(19) United States
(12) Patent Application Publication
(10) Pub. No.: US 2025/0095624 A1
(43) Pub. Date: Mar. 20, 2025

(54) Sound Absorption Sheet and Vehicle

(71) Applicant: BYD Company Limited, Shenzhen (CN)

(72) Inventors: Yongzheng Hu, Shenzhen (CN); Yaxuan Sun, Shenzhen (CN); Yongji Zhao, Shenzhen (CN); Zhufang Yan, Shenzhen (CN)

(21) Appl. No.: 18/967,036

(22) Filed: Dec. 3, 2024

Related U.S. Application Data
(63) Continuation of application No. PCT/CN2023/090643, filed on Apr. 25, 2023.

(30) Foreign Application Priority Data
Jun. 21, 2022 (CN) 202221554310.4

(51) Int. Cl. G10K 11/172; B60R 13/08; G10K 11/162

(52) U.S. Cl. CPC G10K 11/172; B60R 13/0815; G10K 11/162

(57) ABSTRACT

A vehicle includes a sound absorption sheet. The sound absorption sheet includes a plurality of resonance units connected into a single sheet, and each of the plurality of resonance units includes a unit base, a neck, a sound absorption cavity being formed inside the unit base, and a through hole being arranged on the unit base. The neck is arranged in the sound absorption cavity. The neck has a tubular structure. A first end of the neck includes a first opening, and a second end of the neck includes a second opening. The first opening is connected to the through hole and is in communication with the outside. The second end of the neck is located inside the sound absorption cavity, and the second opening is in communication with the sound absorption cavity.

The present disclosure claims priority to Chinese Patent Application No. 202221554310.4, filed on Jun. 21, 2022 and entitled “SOUND ABSORPTION SHEET AND VEHICLE”. The entire content of the above-referenced application is incorporated herein by reference.

### FIELD

The present disclosure relates to the field of sound absorption materials, and more specifically, to a sound absorption sheet and a vehicle.

### BACKGROUND

Noise generated during vehicle operation has complex frequency components concentrated at low frequencies, which easily resonate with human bodies and structures, causing great harm. A conventional sound insulation material uses a homogeneous plate as a sound insulation substrate according to the mass density law. Sound insulation performance may be improved through an application of a viscoelastic damping material, an arrangement of bars, and the like on a surface. However, this solution increases a mass and a thickness of the sound insulation material but cannot significantly improve sound insulation performance at low frequencies.

A structural dimension of a basic unit of an acoustic metamaterial is usually much less than a wavelength of a sound wave, which can break through a mass sound insulation theorem of a traditional material. An acoustic metamaterial with a single resonant sound absorption cavity absorbs sound through local resonance of air in the sound absorption cavity, which can achieve much more sound insulation than the mass theorem. However, a neck is connected with an outside of the sound absorption cavity. Often, a long neck and a large sound absorption cavity are required for low-frequency noise. As such, an acoustic metamaterial with a resonant sound absorption cavity requires large space.

### SUMMARY

A problem to be resolved in the present disclosure is as follows. An existing acoustic metamaterial with a resonant sound absorption cavity often requires a long neck and a large sound absorption cavity for low-frequency noise, and as a result, the acoustic metamaterial with a resonant sound absorption cavity occupies a large space. In view of the problem, the present disclosure provides a sound absorption sheet and a vehicle.

To resolve the foregoing problem, embodiments of the present disclosure provide a sound absorption sheet. The sound absorption sheet includes multiple resonance units connected into a single sheet. Each of the resonance units includes a unit base and a neck. A sound absorption cavity is formed inside the unit base. A through hole is provided on the unit base. The neck is arranged inside the sound absorption cavity. The neck has a tubular structure. A first end of the neck is provided with a first opening. A second end of the neck is provided with a second opening. The first opening is connected with the through hole and is in communication with outside. The second end of the neck is located inside the sound absorption cavity. The second opening is in communication with the sound absorption cavity.

In another aspect, an embodiment of the present disclosure further provides a vehicle, which includes a vehicle structure member and the foregoing sound absorption sheet. The sound absorption sheet is attached to the vehicle structure member. The first opening of the neck of the resonance unit of the sound absorption sheet faces a sound source that needs sound absorption.

### BRIEF DESCRIPTION OF THE DRAWINGS

FIG. 1 is a schematic diagram of a sound absorption sheet according to a first embodiment of the present disclosure;

FIG. 2 is a schematic diagram of a resonance unit of the sound absorption sheet according to the first embodiment of the present disclosure;

FIG. 3 is a schematic diagram of a resonance unit of a sound absorption sheet according to a second embodiment of the present disclosure;

FIG. 4 is a schematic diagram of a sound absorption sheet according to a third embodiment of the present disclosure;

FIG. 5 is a schematic diagram of the resonance unit of the sound absorption sheet according to the third embodiment of the present disclosure;

FIG. 6 is a schematic diagram of a sound absorption sheet according to a fourth embodiment of the present disclosure;

FIG. 7 is a schematic diagram of a resonance unit of the sound absorption sheet according to the fourth embodiment of the present disclosure;

FIG. 8 is a simulation diagram of the sound absorption sheet according to the fourth embodiment of the present disclosure;

FIG. 9 is a schematic diagram of a resonance unit of a sound absorption sheet according to a fifth embodiment of the present disclosure;

FIG. 10 is a schematic diagram of a resonance unit of a sound absorption sheet according to a sixth embodiment of the present disclosure;

FIG. 11 is a schematic diagram of a resonance unit of a sound absorption sheet according to a seventh embodiment of the present disclosure;

FIG. 12 is a schematic diagram of a sound absorption sheet according to an eighth embodiment of the present disclosure; and

FIG. 13 is a schematic diagram of a resonance unit of a sound absorption sheet according to a ninth embodiment of the present disclosure.

### DETAILED DESCRIPTION

To introduce problems to be solved in the present disclosure, solutions, and beneficial effects, the present disclosure is described below in further detail with reference to drawings and embodiments. It should be understood that, specific embodiments described herein are merely used for explaining the present disclosure, and are not intended to limit the present disclosure.

To more intuitively illustrate a sound absorption sheet provided in the embodiments of the present disclosure, each of the drawings in the specification adopts a foreshortened figure.

### First Embodiment

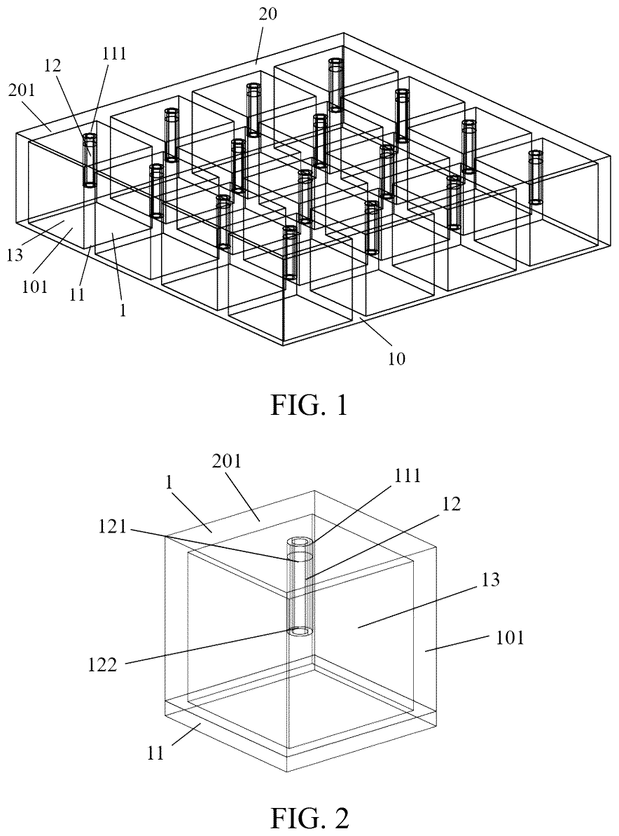

As shown in FIG. 1 and FIG. 2, a sound absorption sheet provided in the first embodiment of the present disclosure includes multiple resonance units 1 connected into a single sheet. Each of the resonance units 1 includes a unit base 11 and a neck 12. A sound absorption cavity 13 is formed inside the unit base 11. A through hole 111 is provided on the unit base 11. The neck 12 is arranged inside the sound absorption cavity 13. The neck 12 has a tubular structure. A first end 121 of the neck 12 is provided with a first opening. A second end 122 of the neck 12 is provided with a second opening. The first end 121 of the neck 12 is fixed to the unit base 11. The first opening is connected with the through hole 111 and is in communication with outside. The second end 122 of the neck is located inside the sound absorption cavity 13. The second opening is in communication with the sound absorption cavity 13. In this way, the neck 12 can bring the outside into communication with the sound absorption cavity 13. A sound wave of a sound source passes through the neck 12 and then enters the sound absorption cavity 13. The sound wave is reflected in the sound absorption cavity 13 multiple times to be attenuated, thereby achieving sound absorption.

In this embodiment, the neck 12 is a straight tube, and the neck 12 is vertically connected with the unit base 11. A length of a part of the neck 12 accommodated in the sound absorption cavity is less than a dimension of the sound absorption cavity 13 in a thickness direction of the sound absorption sheet. In this way, the second opening of the neck 12 is prevented from being blocked as a result of the neck abutting against the unit base 11.

As an alternative, the neck 12 may not be perpendicular to a wall surface of the unit base 11, and instead, may be at an angle relative to the wall surface.

In this embodiment, the neck 12 may be a hard tube, such as a rigid plastic tube or a metal tube. In some alternatives, the neck 12 may be a soft tube. In this case, the soft tube needs to be able to stand upright.

In this embodiment, a cross section of an inner hole of the neck 12 is in a circular shape. In other words, the neck 12 is a cylindrical tube. A diameter of the circular cross section of the inner hole of the neck 12 is in a range of 1 mm to 2 mm.

However, in an alternative, the cross section of the inner hole of the neck 12 may be in an elliptical shape. A major axis of the elliptical cross section of the inner hole of the neck 12 is in a range of 1 mm to 2 mm. A minor axis of the elliptical cross section of the inner hole of the neck 12 is in a range of 1 mm to 2 mm. In another alternative, the cross section of the inner hole of the neck 12 is in a polygonal shape. A side length of the polygonal cross section of the inner hole of the neck 12 is in a range of 1 mm to 2 mm.

In this embodiment, the multiple resonance units 1 are arranged in an array. For example, the multiple resonance units are arranged in a rectangular array, as shown in FIG. 1. However, alternatively, the multiple resonance units may be arranged in an annular array.

An outer edge of a cross section of the unit base 11 perpendicular to the thickness direction of the sound absorption sheet is in a polygonal shape. For example, in FIG. 2, the outer edge of the cross section of the unit base 11 perpendicular to the thickness direction of the sound absorption sheet is a quadrate (a regular quadrilateral) shape. In this way, the unit base 11 is in a square shape. When a dimension of the unit base 11 in the thickness direction of the sound absorption sheet is not equal to the side length of the outer edge of the cross section of the unit base 11 perpendicular to the thickness direction of the sound absorption sheet, the unit base 11 is a cuboid. When the dimension of the unit base 11 in the thickness direction of the sound absorption sheet is equal to the side length of the outer edge of the cross section of the unit base 11 perpendicular to the thickness direction of the sound absorption sheet, the unit base 11 is a cube. A shape of the sound absorption cavity 13 is defined by an inner wall surface of the unit base 11, and the shape of the sound absorption cavity 13 is substantially the same as the shape of the unit base 11.

The outer edge of the cross section of the unit base 11 perpendicular to the thickness direction of the sound absorption sheet is in the polygonal shape. A dimension of the cross section of the unit base 11 perpendicular to the thickness direction of the sound absorption sheet may be kept consistent in the thickness direction of the sound absorption sheet. In this way, the multiple resonance units 1 can form an array structure with edges closely connected.

However, in some alternatives, the dimension of the cross section of the unit base 11 perpendicular to the thickness direction of the sound absorption sheet may be inconsistent in the thickness direction of the sound absorption sheet. However, the multiple resonance units 1 still need to form an array structure with edges closely connected.

The dimension of the sound absorption cavity 13 in the thickness direction of the sound absorption sheet is in a range of 7 mm to 40 mm. A wall thickness of the unit base 11 is in a range of 1 mm to 2 mm. The dimension of the sound absorption cavity 13 in the thickness direction of the sound absorption sheet cannot be excessively large, to avoid impact of space occupation of the sound absorption sheet on arrangement of the sound absorption sheet as a result of an excessively large thickness.

An outer edge of a cross section of the sound absorption cavity 13 perpendicular to the thickness direction of the sound absorption sheet is in a polygonal shape. A side length of the polygon may be greater than or equal to the dimension of the sound absorption cavity 13 in the thickness direction of the sound absorption sheet. In this way, the sound absorption cavity 13 is in a flat shape, so that the entire sound absorption sheet can be made thinner. For example, in FIG. 2, the outer edge of the cross section of the sound absorption cavity 13 perpendicular to the thickness direction of the sound absorption sheet is in a quadrate (regular quadrilateral) shape. In this way, the sound absorption cavity 13 is a cuboid or a cube. For example, the sound absorption cavity 13 may be a cuboid with a length of 30 mm, a width of 30 mm, and a height of 20 mm. A height direction of the sound absorption cavity 13 is the thickness direction of the sound absorption sheet.

The side length of the polygonal cross section of the sound absorption cavity 13 may alternatively be less than the dimension of the sound absorption cavity 13 in the thickness direction of the sound absorption sheet. However, generally, for ease of processing, the side length of the polygonal cross section of the sound absorption cavity 13 is greater than or equal to 7 mm. In addition, to provide as many resonance units 1 as possible on the sound absorption sheet, the side length of the polygonal cross section of the sound absorption cavity 13 may be, for example, less than 3 times the height of the sound absorption cavity 13.

The side length of the polygonal cross section of the sound absorption cavity 13 is adjusted based on a process requirement and a mounting space of the sound absorption sheet.

However, in some alternatives, the sound absorption cavity 13 may be in a cylindrical shape. In other words, the cross section of the sound absorption cavity in the thickness direction of the sound absorption sheet is in a circular shape. In this case, a diameter of the circular cross section of the sound absorption cavity 13 is adjusted based on the process requirement and the mounting space of the sound absorption sheet.

In this embodiment, the inner wall surface of the unit base 11 has all flat surfaces in 6 directions thereof.

In this embodiment, referring to FIG. 1 and FIG. 2, the sound absorption sheet includes an injection molded body 10 and a cover plate 20. The injection molded body 10 is provided with multiple recesses arranged at intervals. The cover plate 20 covers the multiple recesses to form the multiple sound absorption cavities 13. Since the sound absorption cavity 13 cannot be directly formed through one injection molding, the sound absorption sheet needs to be divided into two parts, namely, the injection molded body 10 and the cover plate 20, which are bonded together.

The injection molded body 10 includes multiple injection molded body units 101 connected into a single sheet. The cover plate includes multiple cover plate units 201 connected into a single sheet. The through hole 111 is provided on each of the cover plate units 201. The cover plate units 201 are fixedly connected with openings of the recesses of the injection molded body units 101 to form the unit base 11.

In this embodiment, referring to FIG. 2, the first end 121 of the neck 12 is inserted in the through hole 111. The neck 12 is pressed into the through hole 111 directly through interference fit, which can reduce glue that needs to be used.

According to the sound absorption sheet in the first embodiment of the present disclosure, the neck 12 is arranged inside the sound absorption cavity 13, which can effectively reduce a dimension of the resonance unit 1, and reduce space occupation of the sound absorption sheet. Therefore, the sound absorption sheet can be effectively applied to a place with a limited space, and has a wide application range.

### Second Embodiment

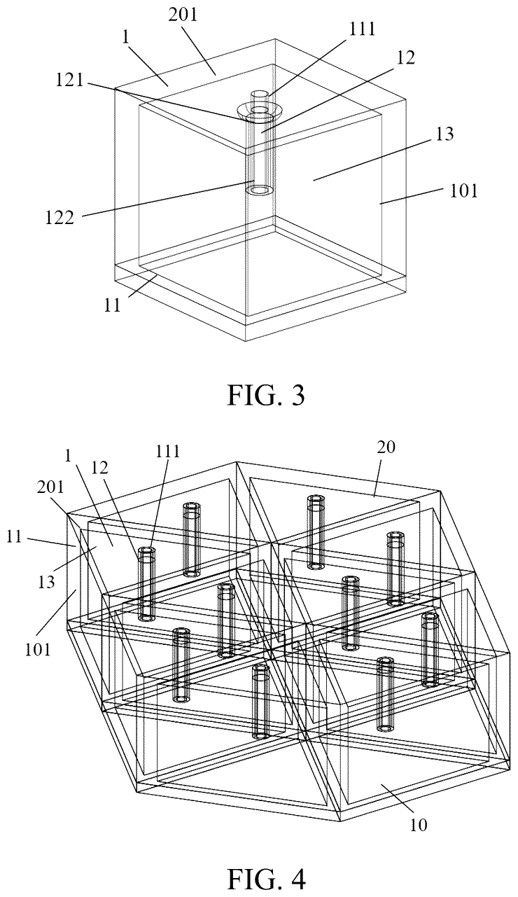

FIG. 3 shows a sound absorption sheet according to the second embodiment of the present disclosure. A difference between the second embodiment and the first embodiment is that an end surface of the first end 121 of the neck 12 is bonded with the inner wall surface of the unit base 11.

In this way, the neck 12 is entirely located in the sound absorption cavity 13. Therefore, the through hole 111 can be arranged to be smaller.

### Third Embodiment

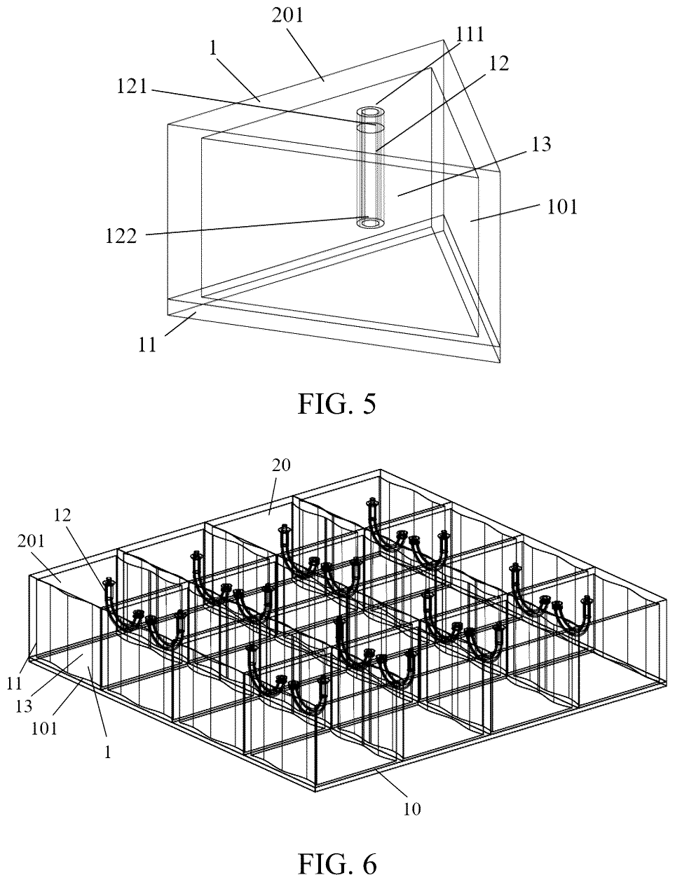

FIG. 4 and FIG. 5 show a sound absorption sheet according to the third embodiment of the present disclosure. A difference between the third embodiment and the first embodiment is that the outer edge of the cross section of the unit base 11 perpendicular to the thickness direction of the sound absorption sheet is in a triangular (trilateral) shape, and the outer edge of the cross section of the sound absorption cavity 13 perpendicular to the thickness direction of the sound absorption sheet is in a triangular (trilateral) shape.

### Fourth Embodiment

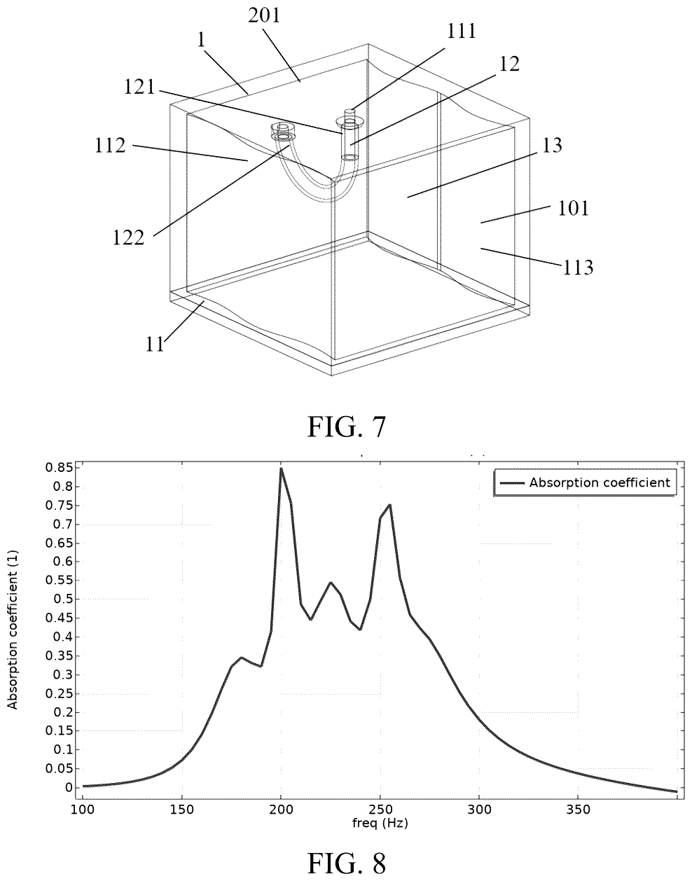

FIG. 6 and FIG. 7 show a sound absorption sheet according to the fourth embodiment of the present disclosure. A difference between the fourth embodiment and the first embodiment is that the neck 12 is a curved tube and the curved tube is U-shaped.

In this embodiment, the neck 12 is a soft tube, such as a rubber tube. Since the neck 12 is a U-shaped curved tube, the second opening of the second end 122 of the neck is in communication with the sound absorption cavity. The length of the part of the neck 12 accommodated in the sound absorption cavity 13 is greater than the dimension of the sound absorption cavity 13 in the thickness direction of the sound absorption sheet. A part of an outer peripheral surface of the neck 12 is fixed to an inner side of the unit base 11 through gluing.

Another difference between the fourth embodiment and the first embodiment is as follows: Referring to FIG. 7, the inner wall surface of the unit base 11 has a first wall surface 112 and a second wall surface 113 opposite to each other. Each of the first wall surface 112 and the second wall surface 113 is provided with a curved surface. The curved surface may be a wavy curved surface.

All wall surfaces other than the wall surface provided with the through hole 111 may be arranged as curved surfaces. When the outer edge of the cross section of the sound absorption cavity 13 perpendicular to the thickness direction of the sound absorption sheet is in a quadrilateral shape, two sets of first wall surfaces 112 and second wall surfaces 113 may be provided. When the outer edge of the cross section of the sound absorption cavity 13 perpendicular to the thickness direction of the sound absorption sheet is in a hexagonal shape, three sets of first wall surfaces 112 and second wall surfaces 113 may be provided, and so on.

The curved surface may alternatively be a zigzag curved surface or a cylindrical surface.

Referring to FIG. 8, in addition, it is found through a simulation that the sound absorption sheet has a good sound absorption effect for noise at an ultra-low frequency (200 Hz to 300 Hz). In FIG. 8, an abscissa represents a frequency (which is represented by freq in the figure), and an ordinate represents a sound absorption coefficient (which is represented by Absorption coefficient in the figure). A sound absorption coefficient closer to 1 indicates a better sound absorption effect.

In this embodiment, the end surface of the first end 121 of the neck 12 is bonded with the inner wall surface of the unit base 111.

Alternatively, the neck 12 may be a hard tube.

### Fifth Embodiment

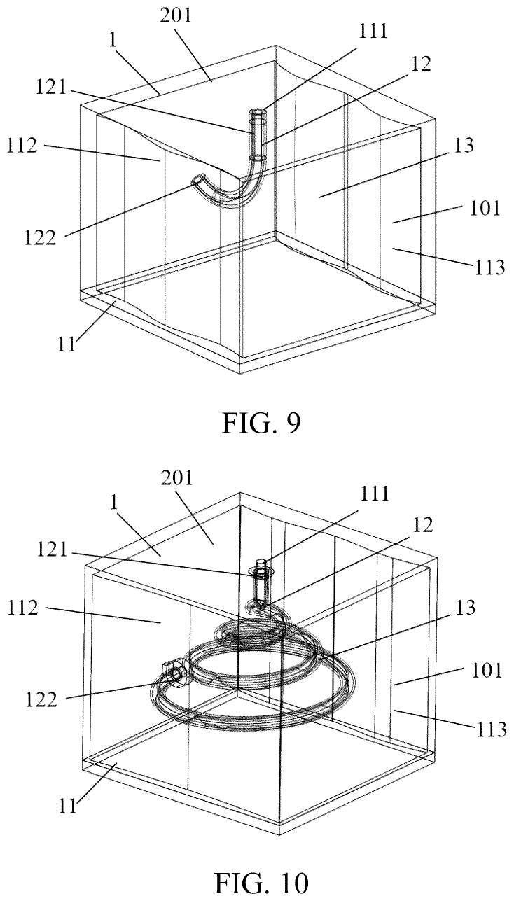

FIG. 9 shows a sound absorption sheet according to the fifth embodiment of the present disclosure. A difference between the fifth embodiment and the fourth embodiment is that the first end 121 of the neck 12 is inserted in the through hole 111 of the unit base 11.

### Sixth Embodiment

FIG. 10 shows a sound absorption sheet according to the sixth embodiment of the present disclosure. A difference between the sixth embodiment and the fifth embodiment is that the curved tube (the neck 12) is curved in a helical shape. In this way, the neck 12 may be arranged longer to absorb low-frequency noise more effectively.

### Seventh Embodiment

FIG. 11 shows a sound absorption sheet according to the seventh embodiment of the present disclosure. A difference between the seventh embodiment and the sixth embodiment is that the outer edge of the cross section of the unit base 11 perpendicular to the thickness direction of the sound absorption sheet is in a triangular (trilateral) shape, and the outer edge of the cross section of the sound absorption cavity 13 perpendicular to the thickness direction of the sound absorption sheet is in a triangular (trilateral) shape.

### Eighth Embodiment

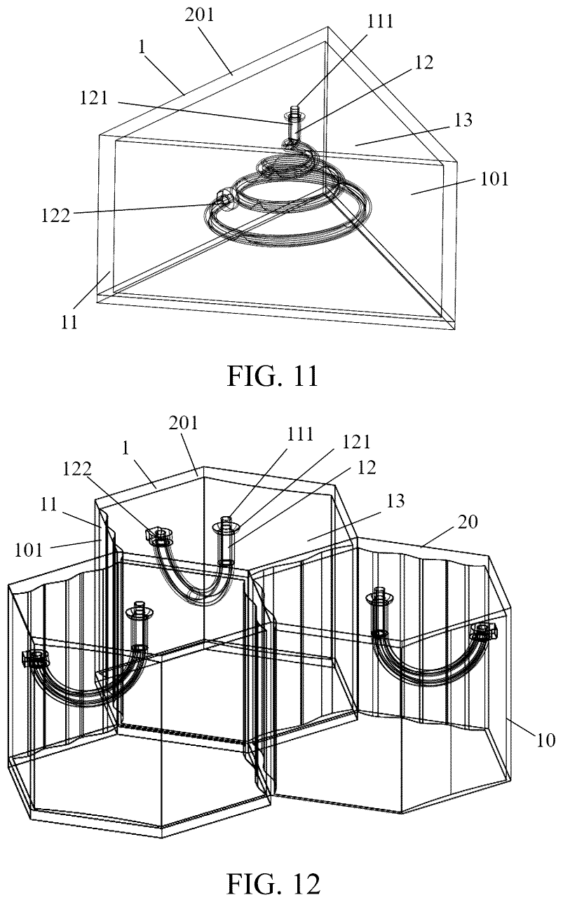

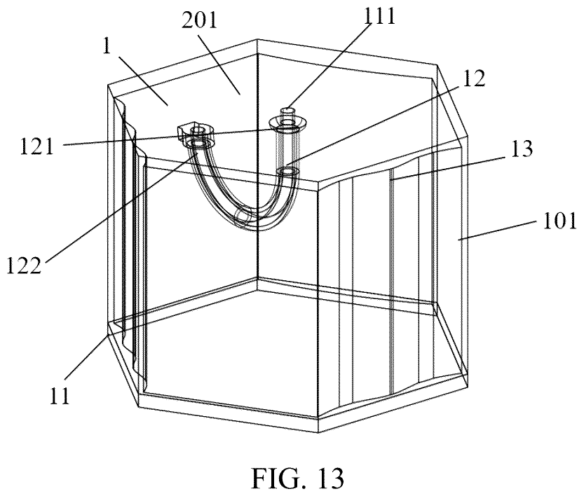

FIG. 12 and FIG. 13 show a sound absorption sheet according to the eighth embodiment of the present disclosure. A difference between the eighth embodiment and the sixth embodiment is that the outer edge of the cross section of the unit base 11 perpendicular to the thickness direction of the sound absorption sheet is in a hexagonal shape, and the outer edge of the cross section of the sound absorption cavity 13 perpendicular to the thickness direction of the sound absorption sheet is in a hexagonal shape. Multiple hexagonal resonance units 1 form a honeycomb structure.

### Ninth Embodiment

The ninth embodiment of the present disclosure provides a vehicle, which includes a vehicle structure member and the sound absorption sheet in the foregoing embodiments. The sound absorption sheet is attached to the vehicle structure member. The first opening of the neck of the resonance unit of the sound absorption sheet faces a sound source that needs sound absorption, to absorb noise.

The vehicle may be a rail vehicle, and the sound absorption sheet is arranged under a floor, in a side body, or in a door.

The vehicle may alternatively be an automobile, and the sound absorption sheet is arranged under a floor, in a side body, in a door, in a front compartment, or in a rear compartment.

The foregoing descriptions are merely exemplary embodiments of the present disclosure, and are not intended to limit the present disclosure. Any modification, equivalent replacement, or improvement made within the spirit and principle of the present disclosure shall fall within the protection scope of the present disclosure.

In the drawings:
10. Injection molded body; 101. Injection molded body unit; 20. Cover plate; 201. Cover plate unit;
1. Resonance unit; 11. Unit base; 111. Through hole; 112. First wall surface; 113. Second wall surface; 12. Neck; 121. First end of a neck; 122. Second end of a neck; 13. Sound absorption cavity.

1. A sound absorption sheet, comprising a plurality of resonance units connected into a single sheet, wherein each of the plurality of resonance units comprises:
a unit base;
a sound absorption cavity being formed inside the unit base;
a through hole being arranged on the unit base; and
a neck, wherein the neck is arranged inside the sound absorption cavity, the neck has a tubular structure, a first end of the neck comprises a first opening, a second end of the neck comprises a second opening, the first opening is connected with the through hole and is in communication with outside, the second end of the neck is located inside the sound absorption cavity, and the second opening is in communication with the sound absorption cavity.

2. The sound absorption sheet according to claim 1, wherein the neck is a straight tube, and a length of a part of the neck accommodated in the sound absorption cavity is less than a dimension of the sound absorption cavity in a thickness direction of the sound absorption sheet.

3. The sound absorption sheet according to claim 1, wherein the neck is a curved tube.

4. The sound absorption sheet according to claim 3, wherein the curved tube is U-shaped or helical.

5. The sound absorption sheet according to claim 1, wherein the first end of the neck is inserted in the through hole or an end surface of the first end of the neck is bonded with an inner wall surface of the unit base.

6. The sound absorption sheet according to claim 1, wherein a cross section of an inner hole of the neck is in a circular shape, and a diameter of the circular cross section of the inner hole of the neck is in a range of about 1 mm to about 2 mm; or
the cross section of the inner hole of the neck is in an elliptical shape, a major axis of the elliptical cross section of the inner hole of the neck is in a range of about 1 mm to about 2 mm, and a minor axis of the elliptical cross section of the inner hole of the neck is in a range of about 1 mm to about 2 mm; or
the cross section of the inner hole of the neck is in a polygonal shape, and a side length of the polygonal cross section of the inner hole of the neck is in a range of about 1 mm to about 2 mm.

7. The sound absorption sheet according to claim 1, wherein the plurality of resonance units are arranged in an array.

8. The sound absorption sheet according to claim 1, wherein an outer edge of a cross section of the unit base perpendicular to a thickness direction of the sound absorption sheet is in a polygonal shape.

9. The sound absorption sheet according to claim 1, wherein a dimension of the sound absorption cavity in a thickness direction of the sound absorption sheet is in a range of about 7 mm to about 40 mm, and a wall thickness of the unit base is in a range of about 1 mm to about 2 mm.

10. The sound absorption sheet according to claim 1, wherein an inner wall surface of the unit base has a first wall surface and a second wall surface opposite to each other, and each of the first wall surface and the second wall surface comprises a curved surface.

11. The sound absorption sheet according to claim 10, wherein the curved surface is a wavy curved surface, a cylindrical surface, or a zigzag curved surface.

12. The sound absorption sheet according to claim 1, further comprises:
an injection molded body; and
a cover plate, wherein the injection molded body comprises a plurality of recesses arranged at intervals, and the cover plate covers the plurality of recesses to form a plurality of sound absorption cavities;
wherein the injection molded body comprises a plurality of injection molded body units connected into the single sheet, the cover plate comprises a plurality of cover plate units connected into the single sheet, the through hole is arranged on each of the plurality of cover plate units, and the plurality of cover plate units are connected with openings of the plurality of recesses of the plurality of injection molded body units to form the unit base.

13. A vehicle, comprising:
a vehicle structure member; and
a sound absorption sheet, wherein the sound absorption sheet is attached to the vehicle structure member, and wherein the sound absorption sheet comprises a plurality of resonance units connected into a single sheet, and each of the plurality of resonance units comprises:
a unit base;
a sound absorption cavity being formed inside the unit base;
a through hole being arranged on the unit base; and
a neck, wherein the neck is arranged inside the sound absorption cavity, the neck has a tubular structure, a first end of the neck comprises a first opening, a second end of the neck comprises a second opening, the first opening is connected with the through hole and is in communication with outside, the second end of the neck is located inside the sound absorption cavity, and the second opening is in communication with the sound absorption cavity;
wherein the first opening of the neck of the resonance unit of the sound absorption sheet faces a sound source that needs sound absorption.

14. The vehicle according to claim 13, wherein the neck is a straight tube, and a length of a part of the neck accommodated in the sound absorption cavity is less than a dimension of the sound absorption cavity in a thickness direction of the sound absorption sheet.

15. The vehicle according to claim 13, wherein the neck is a curved tube.

16. The vehicle according to claim 15, wherein the curved tube is U-shaped or helical.

17. The vehicle according to claim 13, wherein the first end of the neck is inserted in the through hole or an end surface of the first end of the neck is bonded with an inner wall surface of the unit base.

18. The vehicle according to claim 13, wherein a cross section of an inner hole of the neck is in a circular shape, and a diameter of the circular cross section of the inner hole of the neck is in a range of about 1 mm to about 2 mm; or
the cross section of the inner hole of the neck is in an elliptical shape, a major axis of the elliptical cross section of the inner hole of the neck is in a range of about 1 mm to about 2 mm, and a minor axis of the elliptical cross section of the inner hole of the neck is in a range of about 1 mm to about 2 mm; or
the cross section of the inner hole of the neck is in a polygonal shape, and a side length of the polygonal cross section of the inner hole of the neck is in a range of about 1 mm to about 2 mm.

19. The vehicle according to claim 13, wherein the plurality of resonance units are arranged in an array.

20. The vehicle according to claim 13, wherein an outer edge of a cross section of the unit base perpendicular to a thickness direction of the sound absorption sheet is in a polygonal shape.
